(19) United States
(12) Patent Application Publication
(10) Pub. No.: US 2026/0044383 A1
(43) Pub. Date: Feb. 12, 2026

(54) METHOD FOR PERFORMING BUS INSTANCE RESOURCE MANAGEMENT IN UNIVERSAL SERIAL BUS HOST CONTROLLER, AND ASSOCIATED APPARATUS

(71) Applicant: Faraday Technology Corp., Hsin-Chu City (TW)

(72) Inventors: Ching-Lin Hsu, Hsin-Chu City (TW); Chien-Ting Wang, Hsin-Chu City (TW)

(73) Assignee: Faraday Technology Corp., Hsin-Chu City (TW)

(21) Appl. No.: 19/010,182

(22) Filed: Jan. 6, 2025

(30) Foreign Application Priority Data
Aug. 9, 2024 (TW) 113129959

(51) Int. Cl. G06F 9/50

(52) U.S. Cl. CPC G06F 9/5044; G06F 9/5038

(57) ABSTRACT

A method for performing bus instance (BI) resource management in a USB host controller and associated apparatus are provided. The method applicable to the USB host controller includes: establishing a BI bandwidth table for recoding respective bandwidth usage information of multiple BIs of the USB host controller; utilizing a scheduler within the USB host controller to determine whether a predetermined command is received; utilizing the scheduler to determine whether the predetermined command indicates that any endpoint is added; utilizing a resource calculator within the USB host controller to perform a lookup operation on the BI bandwidth table, for determining whether a target bandwidth of a target BI among the multiple BIs exceeds a predetermined bandwidth limit per BI; and utilizing the resource calculator to perform at least one searching operation for collecting at least one remaining bandwidth of at least one other BI for being used by the target BI.

### BACKGROUND OF THE INVENTION

### 1. Field of the Invention

The present invention is related to storage control, and more particularly, to a method for performing bus instance (BI) resource management in a universal serial bus (USB) host controller, and associated apparatus such as an electronic device and a USB host controller within the electronic device.

### 2. Description of the Prior Art

According to the related art, an electronic device may be equipped with a USB system in order to use multiple USB storage devices to store various data, but some problems may occur. For example, each BI among multiple BIs of the USB system cannot know the bandwidth that any other BI among these BIs is using since they are typically managed independently. In a situation where the total bandwidth of the multiple BIs cannot exceed the total available bandwidth of the USB system, each BI among these BIs can only be limited to use an equal share of the total available bandwidth, such as one of multiple equally divided parts of the total available bandwidth. As a result, adding an endpoint may be unsuccessful, causing the overall performance to be degraded. Thus, a novel method and associated architecture are needed for solving the problems without introducing any side effect or in a way that is less likely to introduce a side effect.

### SUMMARY OF THE INVENTION

It is an objective of the present invention to provide a method for performing BI resource management in a USB host controller, and associated apparatus such as an electronic device and a USB host controller within the electronic device, in order to solve the above-mentioned problems.

At least one embodiment of the present invention provides a method for performing BI resource management in a USB host controller, where the method is applicable to the USB host controller. The method may comprise: establishing a BI bandwidth table for recoding respective bandwidth usage information of multiple BIs of the USB host controller; utilizing a scheduler within the USB host controller to determine whether a predetermined command is received; in response to the predetermined command being received, utilizing the scheduler to determine whether the predetermined command indicates that any endpoint is added; in response to the predetermined command indicating that the any endpoint is added, utilizing a resource calculator within the USB host controller to at least perform a lookup operation on the BI bandwidth table, for determining whether a target bandwidth of a target BI among the multiple BIs exceeds a predetermined bandwidth limit per BI; and in response to determining that the target bandwidth exceeds the predetermined bandwidth limit per BI, utilizing the resource calculator to perform at least one searching operation for collecting at least one remaining bandwidth of at least one other BI for being used by the target BI.

At least one embodiment of the present invention provides a USB host controller configured for performing BI resource management, where the USB host controller is positioned within an electronic device. The USB host controller may comprise multiple sub-circuits, and the multiple sub-circuits may comprise an application (AP) interface, a scheduler that is coupled to the AP interface, and a resource calculator that is coupled to the scheduler. The AP interface may be arranged to interact with at least one software layer of the electronic device, the scheduler may be arranged to fetch at least one command from the at least one software layer via the AP interface, and report at least one event to the at least one software layer via the AP interface, and the resource calculator may be arranged to perform calculation regarding BI resource management. For example, the USB host controller is arranged to establish a BI bandwidth table for recoding respective bandwidth usage information of multiple BIs of the USB host controller; the scheduler is arranged to determine whether a predetermined command is received; in response to the predetermined command being received, the scheduler is arranged to determine whether the predetermined command indicates that any endpoint is added; in response to the predetermined command indicating that the any endpoint is added, the resource calculator is arranged to at least perform a lookup operation on the BI bandwidth table, for determining whether a target bandwidth of a target BI among the multiple BIs exceeds a predetermined bandwidth limit per BI; and in response to determining that the target bandwidth exceeds the predetermined bandwidth limit per BI, the resource calculator is arranged to perform at least one searching operation for collecting at least one remaining bandwidth of at least one other BI for being used by the target BI.

At least one embodiment of the present invention provides an electronic device configured for performing BI resource management, where the electronic device may comprise a main circuit, and the main circuit may comprise a USB host controller. More particularly, the USB host controller may comprise multiple sub-circuits, and the multiple sub-circuits may comprise an AP interface, a scheduler that is coupled to the AP interface, and a resource calculator that is coupled to the scheduler. The AP interface may be arranged to interact with at least one software layer of the electronic device, the scheduler may be arranged to fetch at least one command from the at least one software layer via the AP interface, and report at least one event to the at least one software layer via the AP interface, and the resource calculator may be arranged to perform calculation regarding BI resource management. For example, the USB host controller is arranged to establish a BI bandwidth table for recoding respective bandwidth usage information of multiple BIs of the USB host controller; the scheduler is arranged to determine whether a predetermined command is received; in response to the predetermined command being received, the scheduler is arranged to determine whether the predetermined command indicates that any endpoint is added; in response to the predetermined command indicating that the any endpoint is added, the resource calculator is arranged to at least perform a lookup operation on the BI bandwidth table, for determining whether a target bandwidth of a target BI among the multiple BIs exceeds a predetermined bandwidth limit per BI; and in response to determining that the target bandwidth exceeds the predetermined bandwidth limit per BI, the resource calculator is arranged to perform at least one searching operation for collecting at least one remaining bandwidth of at least one other BI for being used by the target BI.

It is an advantage of the present invention that, through proper design, the present invention method, as well as the associated apparatus such as the electronic device and the USB host controller therein, can dynamically manage the bandwidths respectively used by the multiple BIs of the USB host controller, and more particularly, increase the current bandwidth of a target BI among the multiple BIs with an increment of the required bandwidth of the currently selected endpoint (e.g., an added endpoint) managed by the target BI to reach the predetermined bandwidth limit per BI such as 10 gigabits per second (Gbps) for the USB system, having no need to be limited by an improper pseudo limit such as an equal share of the total available bandwidth of the USB controller as suggested in a pseudo limit bandwidth control scheme of the related art. In addition, the present invention method and apparatus can solve the related art problems without introducing any side effect or in a way that is less likely to introduce a side effect.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an electronic device equipped with a USB system according to an embodiment of the present invention.

FIG. 2 illustrates a BI-based resource control scheme of a method for performing BI resource management in a USB host controller according to an embodiment of the present invention.

FIG. 3 illustrates a routing control scheme of the method according to an embodiment of the present invention.

FIG. 4 illustrates a bandwidth control scheme of the method according to an embodiment of the present invention.

FIG. 5 illustrates a scheduler-side working flow of the method according to an embodiment of the present invention.

FIG. 6 illustrates a resource-calculator-side working flow of the method according to the embodiment shown in FIG. 5.

FIG. 7 illustrates a working flow of the method according to an embodiment of the present invention.

### DETAILED DESCRIPTION

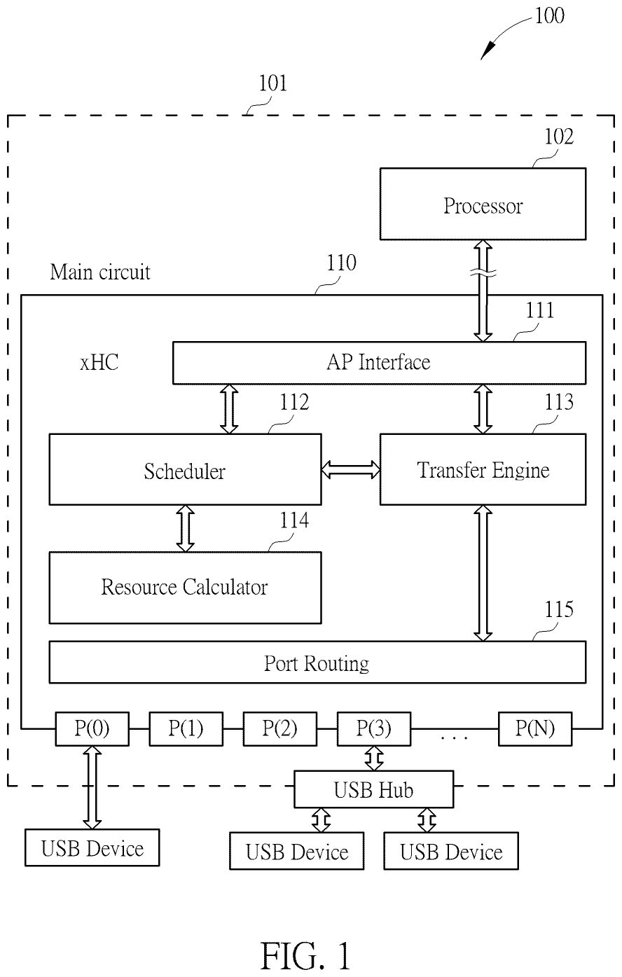

FIG. 1 is a diagram of an electronic device 100 equipped with a USB system according to an embodiment of the present invention. The electronic device 100 may comprise a main circuit 101, and more particularly, may comprise at least one processor (e.g., one or more processor) which may be collectively referred to as the processor 102, a random access memory (RAM), at least one bus, and various kinds of controllers such as a display controller for controlling a display device of the electronic device 100, a memory controller for controlling at least one memory such as the RAM, an extensible host controller (xHC) 110, etc., all of which may be positioned on the main circuit 101, and the processor 102 may be arranged to run multiple program modules in at least one software layer (e.g., one or more software layers) of the electronic device 100, such as an operating system (OS), various kinds of drivers, various kinds of applications (AP), etc., for controlling operations of the electronic device 100, where the drivers may comprise an extensible host controller driver (xHCD), a USB driver (USBD) and one or more class drivers, but the present invention is not limited thereto. According to some embodiments, the hardware architecture of the main circuit 101 and/or the software architecture of the multiple program modules in the aforementioned at least one software layer may vary. Examples of the electronic device 100 may include, but are not limited to: a personal computer such as a desktop computer and a laptop computer, an all-in-one (AIO) computer, a tablet computer, a multifunctional mobile phone and a wearable device.

As shown in FIG. 1, the xHC 110 in the hardware architecture of the main circuit 101 may comprise multiple sub-circuits, such as an AP interface 111, a scheduler 112, a transfer engine 113, a resource calculator 114, a port routing circuit 115 (labeled “Port Routing” for brevity) and multiple ports such as (N+1) ports {P(0), P(1), P(2), P(3), . . . , P(N), with “N” being a positive integer. For example, the xHC 110 may utilize the AP interface 111 to interact with the aforementioned at least one software layer, and the associated operations of the other components within the xHC 110 may comprise:
(1) utilizing the scheduler 112 to fetch a Command Ring, report one or more command completion events, arrange the transfer order of all endpoints and send one or more requests to the transfer engine 113, where the Command Ring may be used by the aforementioned at least one software layer to pass multiple commands to the host controller such as the xHC 110, for example, some commands among the multiple commands may be directed at the host controller, and some other commands among the multiple commands may be directed at particular devices connected to the host controller;
(2) utilizing the transfer engine 113 to receive the one or more requests from the scheduler 112, fetch one or more Transfer Request Blocks (TRBs), report one or more transfer events, and handle the associated USB transaction sequence, where a Transfer Ring such as an array of TRBs may be used for the transfer, for example, each TRB among the TRBs may point to a block of contiguous data (having the size up to 64 kilobytes (KB)) that will be transferred between the hardware circuits of the xHC 110 and the memory (e.g., the RAM) on the main circuit 101 as a single unit;
(3) utilizing the resource calculator 114 to maintain the BI resource information, maintain at least one BI-related table such as a BI mapping table, receive a Check request such as a Check Bandwidth request from the scheduler 112 to find the resource information of any selected endpoint (EP) number in a situation where the scheduler 112 determines that the EP indicated by this selected EP number is added, and receive a Remove request such as a Remove Bandwidth request from the scheduler 112 to remove the resource of any selected EP number in a situation where the scheduler 112 determines that the EP indicated by this selected EP number is dropped; and
(4) utilizing the port routing circuit 115 to route the USB data from a certain root hub port to the transfer engine 113 for the USB IN (or inward) transfer, and route the USB data from the transfer engine 113 to a certain root hub port for the USB OUT (or outward) transfer;
where the xHC 110 (or the resource calculator 114 therein) may be arranged to establish the aforementioned at least one BI-related table, but the present invention is not limited thereto. In some examples, the associated operations of these components within the xHC 110 may vary. In addition, the USB system may comprise the xHC 110 and one or more USB hubs. For example, any USB device among multiple USB devices may be coupled to the xHC 110 via one of the (N+1) ports {P(0), P(1), P(2), P(3), . . . , P(N)}, directly or indirectly.

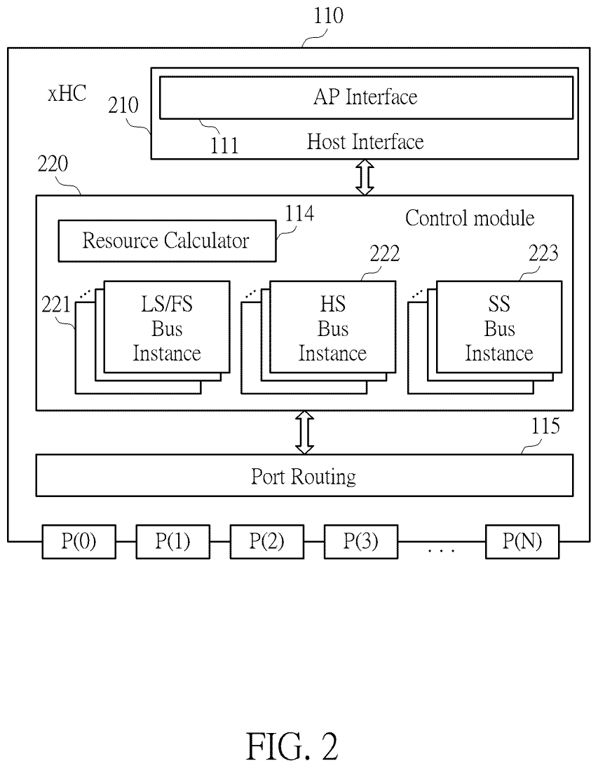

FIG. 2 illustrates a BI-based resource control scheme of a method for performing BI resource management in a USB host controller such as the xHC 110 according to an embodiment of the present invention. For example, a host interface 210 within the xHC 110 may comprise the AP interface 111, and a control module 220 within the xHC 110 may comprise (M+1) BIs {BI(m)|m=0, . . . , M} (i.e., the BIs {BI(0), BI(1), . . . , BI(M)}, with “M” representing a positive integer), such as one or more low speed (LS)/full speed (FS) BIs {BI(m)} 221, one or more high speed (HS) BIs {BI(m)} 222 and one or more super speed (SS) BIs {BI(m)} 223 (respectively labeled “LS/FS Bus Instance”, “HS Bus Instance” and “SS Bus Instance” for better comprehension), where the scheduler 112, the transfer engine 113 and the resource calculator 114 may be integrated into the control module 220, the scheduler 112 and the transfer engine 113 (not shown in FIG. 2 for brevity) may be coupled between the AP interface 111, the resource calculator 114 and the port routing circuit 115 as shown in FIG. 1, and the (M+1) BIs {BI(m)|m=0, . . . , M} mentioned above does not overlap with the scheduler 112 and the transfer engine 113. In addition, the (M+1) BIs {BI(m)|m=0, . . . , M} (e.g., the one or more LS/FS BIs {BI(m)} 221, the one or more HS BIs {BI(m)} 222 and the one or more SS BIs {BI(m)} 223) may be arranged to manage multiple root hub ports within the xHC 110, respectively.

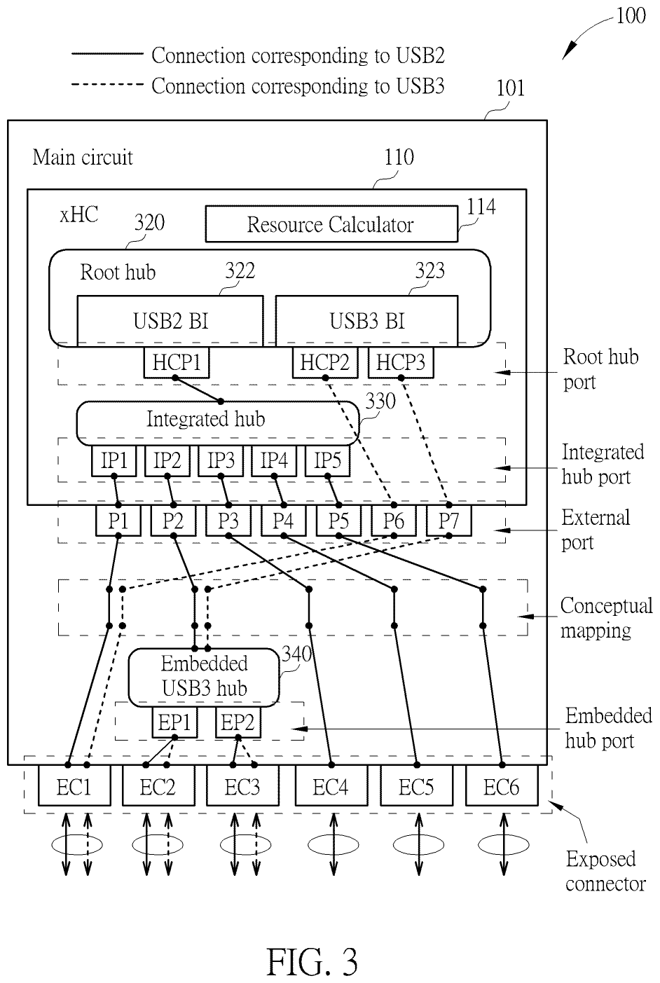

FIG. 3 illustrates a routing control scheme of the method according to an embodiment of the present invention. The xHC 110 may comprise a root hub 320 equipped with (M+1) root hub ports {HCP(i)|i=1, . . . , (M+1)} (e.g., the root hub ports HCP1, HCP2 and HCP3), and an integrated hub 330 equipped with J integrated hub ports {IP(j)|j=1, . . . , J} (e.g., the integrated hub ports IP1, IP2, IP3, IP4 and IP5), and further comprise K external ports {P(k)|k=1, . . . , K} (e.g., the external ports P1, P2, P3, P4, P5, P6 and P7), where the K external ports {P(k)|k=1, . . . , K} may represent the (N+1) ports {P(0), P(1), P(2), P(3), . . . , P(N) shown in FIG. 1, and “J” may be a positive integer and K=(N+1), but the present invention is not limited thereto. According to some embodiments, the architecture of the xHC 110 may vary. In addition, the xHC 110 may be compatible or backward compatible to one or more versions of USB specifications, such as USB 2.0 (or “USB2” for brevity) and USB 3.0, 3.1, etc. (or “USB3” for brevity). More particularly, the BIs {BI(m)|m=0, . . . , M} (e.g., the BIs {BI(0), BI(1), . . . , BI(M)}) of the xHC 110 may comprise one or more USB2 BIs {BI(m)} 322 arranged to manage one or more root hub ports {HCP(i)} complying with the USB2 protocol, and one or more USB3 BIs {BI(m)} 323 arranged to manage one or more root hub ports {HCP(i)} complying with the USB3 protocol. For example, the one or more USB2 BIs {BI(m)} 322 may comprise one BI BI(m) managing one root hub port HCP(i) complying with the USB2 protocol, and the one or more USB3 BIs {BI(m)} 323 may comprise two BIs {BI(m)} respectively managing two root hub ports {HCP(i)} complying with the USB3 protocol.

As shown in FIG. 3, the connections corresponding to USB2 may be arranged to start from the root hub port HCP1, pass through the integrated hub ports IP1, IP2, IP3, IP4 and IP5, the external ports P1, P2, P3, P4 and P5, with some of them passing through an embedded USB3 hub 340 on the main circuit 101 and the embedded hub ports EP1 and EP2 of the embedded USB3 hub 340, and reach the exposed connector EC1, EC2, EC3, EC4, EC5 and EC6, and the connections corresponding to USB3 may be arranged to start from the root hub ports HCP2 and HCP3, pass through the external ports P6 and P7, with some of them passing through the embedded USB3 hub 340 and the embedded hub ports EP1 and EP2 thereof, and reach the exposed connector EC1, EC2 and EC3, but the present invention is not limited thereto. According to some embodiments, the architecture of the xHC 110 and the connections such as that corresponding to USB2 and USB3 may vary.

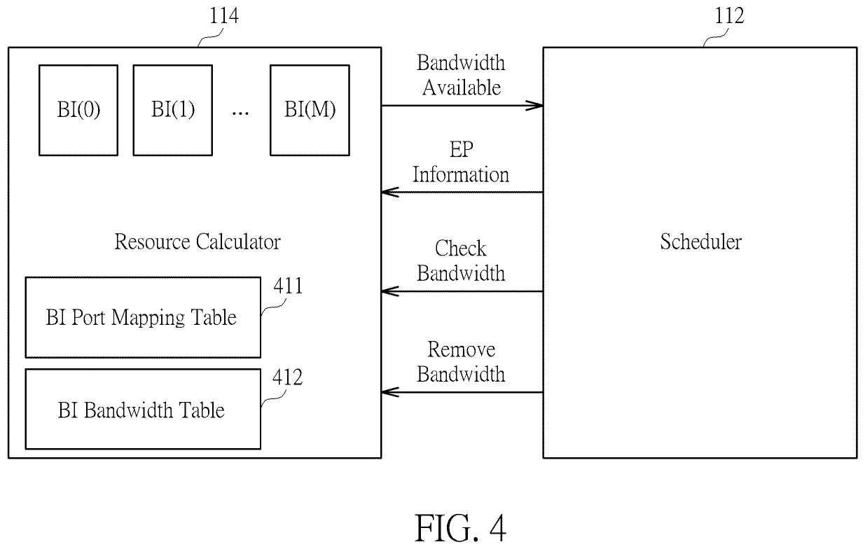

FIG. 4 illustrates a bandwidth control scheme of the method according to an embodiment of the present invention, where the associated signals on the interface between the resource calculator 114 and the scheduler 112 may comprise a Bandwidth Available indication signal for carrying a Bandwidth Available indication, an endpoint (EP) information signal for carrying EP information, a Check Bandwidth request signal for carrying the Check Bandwidth request, and a Remove Bandwidth request signal for carrying the Remove Bandwidth request. The scheduler 112 may send the EP information to the resource calculator (RC) 114, and in response to a change regarding endpoint, selectively assert the Check request such as the Check Bandwidth request or the Remove request such as the Remove Bandwidth request to the resource calculator 114, for obtaining the Bandwidth Available indication from the resource calculator 114 to determine whether it is the case of Bandwidth Available or the case of Bandwidth not Available as reported by the resource calculator 114, to allow the xHC 110 to perform the BI management with the aid of the resource calculator 114, in order to enhance the overall performance. In addition, the resource calculator 114 may calculate the values within each BI-related table of the aforementioned at least one BI-related table. For example, the resource calculator 114 may calculate BI-related values respectively corresponding to the (M+1) BIs {BI(0), BI(1), . . . , BI(M)}, such as the bandwidths {BW(0), BW(1), . . . , BW(M)} respectively used by the (M+1) BIs {BI(0), BI(1), . . . , BI(M)} (labeled “BI(0)”, “BI(1)” . . . and “BI(M)” for brevity), and record these BI-related values into the aforementioned at least one BI-related table, but the present invention is not limited thereto. Additionally, the aforementioned at least one BI-related table may comprise a first BI-related table and a second BI-related table, and the xHC 110 (or the resource calculator 114 therein) may establish the first BI-related table such as a BI and port mapping table (or “the BI port mapping table” for brevity) 411 regarding the BI and port mapping, and the second BI-related table such as a BI bandwidth table 412 regarding the BI bandwidth. More particularly, the resource calculator 114 may use the BI port mapping table 411 to record the BI and port mapping information for indicating mapping relationships (e.g., one-to-one mapping relationships) between the (M+1) BIs {BI(0), BI(1), . . . , BI(M)} and the (M+1) root hub ports {HCP(0), HCP(1), . . . , HCP(M)}, such as a one-to-one bidirectional mapping relationship between the m_{A}^{th} BI BI(m_{A}) among the (M+1) BIs {BI(0), BI(1), . . . , BI(M)} and the myth root hub port HCP(m_{B}) among the (M+1) root hub ports {HCP(0), HCP(1), . . . , HCP(M)}, and use the BI bandwidth table 412 to record respective bandwidth usage information {BW_usage_info(0), BW_usage_info(1), . . . , BW_usage_info(M)} of the (M+1) BIs {BI(0), BI(1), . . . , BI(M)}, where “m_{A}” may be any non-negative integer within the interval [0, M], and “m_{B}” may be any non-negative integer within the interval [0, M].

Regarding the BI bandwidth table 412, the bandwidth usage information {BW_usage_info(0), BW_usage_info(1), . . . , BW_usage_info(M)} therein may be implemented in multiple ways. For example, the respective bandwidth usage information {BW_usage_info(0), BW_usage_info(1), . . . , BW_usage_info(M)} of the (M+1) BIs {BI(0), BI(1), . . . , BI(M)} may represent the bandwidths {BW(0), BW(1), . . . , BW(M)} respectively used by the (M+1) BIS {BI(0), BI(1), . . . , BI(M)}, where any bandwidth BW(m) among the bandwidths {BW(m)|m=0, . . . , M} respectively used by the BIs {BI(m)|m=0, . . . , M} (e.g., the BIs {BI(0), BI(1), . . . , BI(M)}) may represent the capacity for data transfer of the corresponding BI BI(m), such as the maximum data transfer rate of the corresponding BI BI(m). For another example, the respective bandwidth usage information {BW_usage_info(0), BW_usage_info(1), . . . , BW_usage_info(M)} of the (M+1) BIs {BI(0), BI(1), . . . , BI(M)} may represent the local (or BI-owned) bandwidths {BW_remain_local(0), BW_remain_local(1), . . . , BW_remain_local(M)} available for being used by the (M+1) BIs {BI(0), BI(1), . . . , BI(M)} within the quota corresponding to a predetermined bandwidth limit per BI BW_limit_per_BI (e.g., 10 Gbps), and the relationship between the local (or BI-owned) bandwidths {BW_remain_local(0), BW_remain_local(1), . . . BW_remain_local(M)} and the bandwidths {BW(0), BW(1), . . . , BW(M)} may be expressed as follows:

BW_remain_local(0)=(BW_limit_per_BI−BW(0));

BW_remain_local(1)=(BW_limit_per_BI−BW(1)); . . . and

BW_remain_local(M)=(BW_limit_per_BI−BW(M));

where BW_remain_local(m)=(BW_limit_per_BI−BW(m)). For better comprehension, the bandwidth usage information {BW_usage_info(m)|m=0, . . . , M} (e.g., the bandwidths {BW(m)|m=0, . . . , M} or the local (or BI-owned) bandwidths {BW_remain_local(m)|m=0, . . . , M}) may be measured in unit of Gbps, but the present invention is not limited thereto. According to some embodiments, the bandwidth usage information {BW_usage_info(m)|m=0, . . . , M} may be measured in unit of megabits per second (Mbps).

Regarding the requests of the scheduler 112, the scheduler 112 may utilize the Check request such as the Check Bandwidth request to request the resource calculator 114 to check if the bandwidth available, where the resource calculator 114 may respond with the bandwidth (BW) status to the scheduler 112; and the scheduler 112 may utilize the Remove request such as the Remove Bandwidth request to request the resource calculator 114 to remove the required bandwidth of an endpoint being dropped.

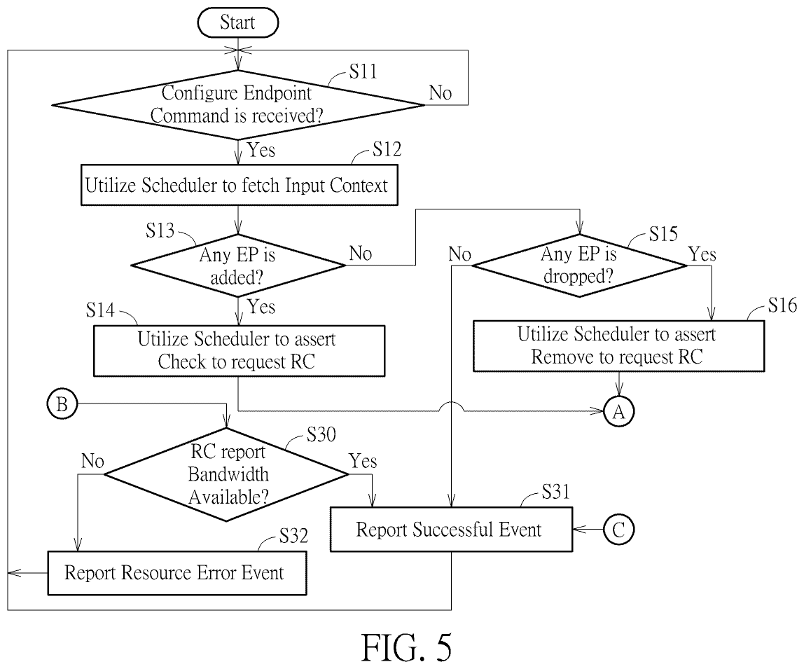

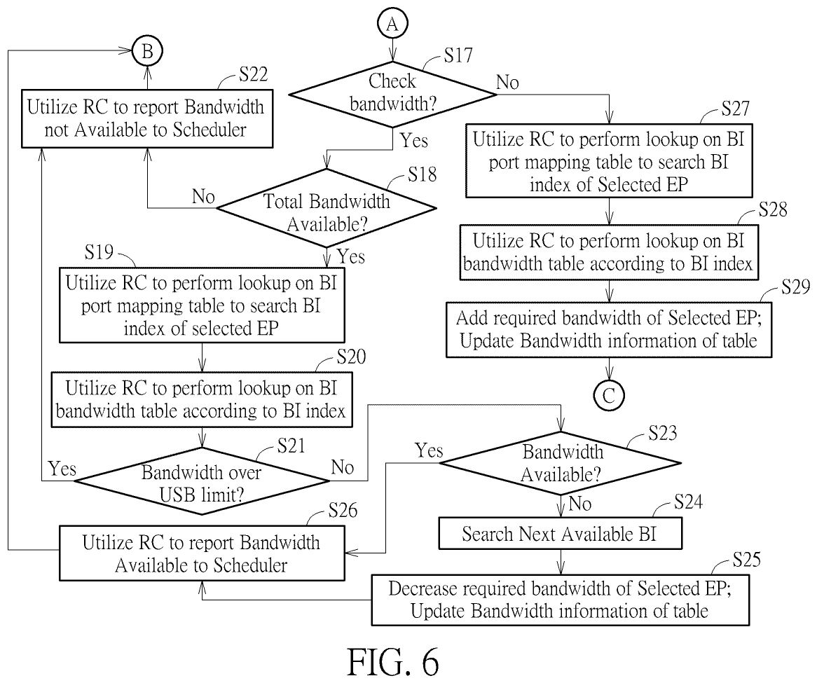

FIG. 5 and FIG. 6 respectively illustrate a scheduler-side working flow and a resource-calculator-side working flow of the method according to an embodiment of the present invention. For example, the scheduler 112 may operate according to the scheduler-side working flow shown in FIG. 5, and the resource calculator 114 (labeled “RC” for brevity) may operate according to the resource-calculator-side working flow shown in FIG. 6, where the scheduler-side working flow (or some steps among Steps S11-S16 and S30-S32 therein) and the resource-calculator-side working flow (or some steps among Steps S17-S29 therein) may be connected to each other via nodes A, B and C, but the present invention is not limited thereto. In addition, when there is any change of endpoint (labeled “EP” for brevity), the xHC 110 may utilize the scheduler 112 to assert the Check request (e.g., the Check Bandwidth request shown in FIG. 4) or the Remove request (e.g., the Remove Bandwidth request shown in FIG. 4) to the resource calculator 114 to perform the BI management with the aid of the resource calculator 114, in order to enhance the overall performance.

In Step S11, the xHC 110 may utilize the scheduler 112 to determine whether a predetermined command such as a Configure Endpoint Command is received. If Yes, Step S12 is entered; if No, Step S11 is re-entered to wait for the predetermined command such as the Configure Endpoint Command.

In Step S12, the xHC 110 may utilize the scheduler 112 to fetch at least one input context (e.g., one or more input contexts) from the predetermined command such as the Configure Endpoint Command.

In Step S13, according to the aforementioned at least one input context of the predetermined command (e.g., the Configure Endpoint Command) that is just fetched in Step S12, the xHC 110 may utilize the scheduler 112 to determine whether any endpoint is added. If Yes, Step S14 is entered; if No, Step S15 is entered.

In Step S14, the xHC 110 may utilize the scheduler 112 to assert the Check request such as the Check Bandwidth request (labeled “Check” for brevity) to request the resource calculator 114. Afterward, Step S17 shown in FIG. 6 is entered via the node A.

In Step S15, according to the aforementioned at least one input context of the predetermined command (e.g., the Configure Endpoint Command) that is just fetched in Step S12, the xHC 110 may utilize the scheduler 112 to determine whether any endpoint is dropped. If Yes, Step S16 is entered; if No, Step S31 is entered.

In Step S16, the xHC 110 may utilize the scheduler 112 to assert the Remove request such as the Remove Bandwidth request (labeled “Remove” for brevity) to request the resource calculator 114. Afterward, Step S17 shown in FIG. 6 is entered via the node A.

In Step S17, the xHC 110 may utilize the resource calculator 114 to determine whether the Check request such as the Check Bandwidth request is asserted (labeled “Check bandwidth” for brevity). If Yes, in a situation where the Check request such as the Check Bandwidth request is asserted, Step S18 is entered; if No, in a situation where the Remove request such as the Remove Bandwidth request is asserted, Step S27 is entered.

In Step S18, the xHC 110 may utilize the resource calculator 114 to determine whether there remains a total bandwidth BW_remain available for use (labeled “Total Bandwidth Available” for brevity), such as a non-zero remaining bandwidth BW_remain which may be equal to the difference (BW_total_available−Σ_{m=0 . . . . M} BW(m)) between the total available bandwidth BW_total_available of the xHC 110 and the summation Σ_{m=0 . . . M} BW(m) (or (BW(0)+ . . . +BW(M))) of the bandwidths {BW(m)|m=0, . . . , M} respectively used by the BIs {BI(m)|m=0, . . . , M}. If Yes, Step S19 is entered; if No, in a situation where the remaining bandwidth BW_remain is equal to zero, Step S22 is entered.

In Step S19, the xHC 110 may utilize the resource calculator 114 to perform lookup (e.g., a first lookup operation) on the BI port mapping table 411 to search the BI index of the currently selected endpoint (e.g., the added endpoint as determined in Step S13), for determining that a target BI BI(m) for managing the currently selected endpoint is the BI BI(m) indicated by this BI index among the BIs {BI(m)|m=0, . . . , M}.

TABLE 1A

| BI index | Root hub port |
|---|---|
| m = 0 | HCP(i(0)) |
| m = 1 | HCP(i(1)) |
| . . . | . . . |
| m = M | HCP(i(M)) |

Table 1A illustrates an example of the BI port mapping table 411, where the symbol “ . . . ” may indicate that some table contents therein may have been omitted for brevity, the BI indexes {m=0, m=1, . . . , m=M} therein may represent the (M+1) BIs {BI(0), BI(1), . . . , BI(M), respectively, and the resource calculator 114 may record the root hub ports {HCP(i(0)), HCP(i(1)), . . . , HCP(i(M))} managed by the (M+1) BIs {BI(0), BI(1), . . . , BI(M), respectively, but the present invention is not limited thereto. In some examples, the table format of the BI port mapping table 411, the table contents in the BI port mapping table 411, and/or the arrangement of the table contents therein may vary. In addition, for better comprehension, the endpoints managed by the (M+1) BIs {BI(0), BI(1), . . . , BI(M) may be expressed with the endpoints {{EndPt(0, 1), EndPt(0, 2), . . . }, {EndPt(1, 1), EndPt(1, 2), . . . }, . . . , {EndPt(M, 1), EndPt(M, 2), . . . }}, respectively, but the present invention is not limited thereto.

TABLE 1B

| Root hub port | BI index |
|---|---|
| HCP(0) | m = m(0) |
| HCP(1) | m = m(1) |
| . . . | . . . |
| HCP(M) | m = m(M) |

Table 1B illustrates another example of the BI port mapping table 411, where the symbol “ . . . ” may indicate that some table contents therein may have been omitted for brevity, the BI indexes {m=m(0), m=m(1), . . . , m=m(M)} therein may represent the BIs {BI(m(0)), BI(m(1)), . . . , BI(m(M)) among the (M+1) BIs {BI(0), BI(1), . . . , BI(M), respectively, and the resource calculator 114 may record the BI indexes {m=m(0), m=m(1), . . . , m=m(M)} of the BIs {BI(m(0)), BI(m(1)), . . . , BI(m(M)) that manage the (M+1) root hub ports {HCP(0), HCP(1), . . . , HCP(M)}, respectively, but the present invention is not limited thereto. In some examples, the table format of the BI port mapping table 411, the table contents in the BI port mapping table 411, and/or the arrangement of the table contents therein may vary. In addition, for better comprehension, the endpoints managed by the BIs {BI(m(0)), BI(m(1)), . . . , BI(m(M)) may be expressed with the endpoints {{EndPt(0, 1), EndPt(0, 2), . . . }, {EndPt(1, 1), EndPt(1, 2), . . . }, . . . , {EndPt(M, 1), EndPt(M, 2), . . . }}, respectively, but the present invention is not limited thereto.

In Step S20, the xHC 110 may utilize the resource calculator 114 to perform lookup (e.g., a second lookup operation) on the BI bandwidth table 412 according to the BI index (e.g., the BI index that is just found in Step S19), to determine the bandwidth usage information BW_usage_info(m) of the target BI BI(m) (e.g., the BI BI(m) indicated by the BI index that is just found in Step S19).

TABLE 2A

| BI index | Bandwidth |
|---|---|
| m = 0 | BW(0) |
| m = 1 | BW(1) |
| . . . | . . . |
| m = M | BW(M) |

Table 2A illustrates an example of the BI bandwidth table 412, where the symbol “ . . . ” may indicate that some table contents therein may have been omitted for brevity, the BI indexes {m=0, m=1, . . . , m=M} therein may represent the (M+1) BIs {BI(0), BI(1), . . . , BI(M), respectively, and the resource calculator 114 may record the bandwidths {BW(0), BW(1), . . . , BW(M)} respectively used by the (M+1) BIs {BI(0), BI(1), . . . , BI(M)}, but the present invention is not limited thereto. In some examples, the table format of the BI bandwidth table 412, the table contents in the BI bandwidth table 412, and/or the arrangement of the table contents therein may vary.

TABLE 2B

| BI index | BI-owned Bandwidth |
|---|---|
| m = 0 | BW remain local(0) |
| m = 1 | BW remain local(1) |
| . . . | . . . |
| m = M | BW remain local(M) |

Table 2B illustrates another example of the BI bandwidth table 412, where the symbol “. . . ” may indicate that some table contents therein may have been omitted for brevity, the BI indexes {m=0, m=1, . . . , m=M} therein may represent the (M+1) BIs {BI(0), BI(1), . . . , BI(M), respectively, and the resource calculator 114 may record the local (or BI-owned) bandwidths {BW_remain_local(0), BW_remain_local(1), . . . , BW_remain_local(M)} available for being used by the (M+1) BIs {BI(0), BI(1), . . . , BI(M)} within the quota corresponding to the predetermined bandwidth limit per BI BW_limit_per_BI, such as the local (or BI-owned) bandwidths {BW_remain_local(0)=(BW_limit_per_BI−BW(0)), BW_remain_local(1)=(BW_limit_per_BI−BW(1)), . . . , BW_remain_local(M)=(BW_limit_per_BI−BW(M))}, where the local (or BI-owned) bandwidths {BW_remain_local(0), BW_remain_local(1), . . . , BW_remain_local(M)} may also be referred to as the remaining local (or BI-owned) bandwidths {BW_remain_local(0), BW_remain_local(1), . . . , BW_remain_local(M)}, but the present invention is not limited thereto. In some examples, the table format of the BI bandwidth table 412, the table contents in the BI bandwidth table 412, and/or the arrangement of the table contents therein may vary.

As BW_remain_local(m)=(BW_limit_per_BI−BW(m)), the xHC 110 may adopt any example among the examples respectively shown in Table 2A and Table 2B, and perform the associated operations corresponding to the aforementioned any example. When adopting the example shown in Table 2A, in Step S20, the xHC 110 may utilize the resource calculator 114 to perform the lookup (e.g., the second lookup operation) on the BI bandwidth table 412 according to the BI index (e.g., the BI index that is just found in Step S19), to determine the bandwidth usage information BW_usage_info(m) of the target BI BI(m), such as the current bandwidth BW(m) of the target BI BI(m). When adopting the example shown in Table 2B, in Step S20, the xHC 110 may utilize the resource calculator 114 to perform the lookup (e.g., the second lookup operation) on the BI bandwidth table 412 according to the BI index (e.g., the BI index that is just found in Step S19), to determine the bandwidth usage information BW_usage_info(m) of the target BI BI(m), such as the local (or BI-owned) bandwidth BW_remain_local(m) of the target BI BI(m).

In Step S21, the xHC 110 may utilize the resource calculator 114 to determine whether the current bandwidth BW(m) of the target BI BI(m) (e.g., the BI BI(m) indicated by the BI index that is just found in Step S19) has reached the predetermined bandwidth limit per BI BW_limit_per_BI such as 10 Gbps for the USB system so that any increment to be added onto the current bandwidth BW(m) of the target BI BI(m) will make the resultant (or increased) bandwidth BW(m) of the target BI BI(m) exceed the predetermined bandwidth limit per BI BW_limit_per_BI such as 10 Gbps (labeled “Bandwidth over USB limit” for brevity). If Yes, Step S22 is entered; if No, Step S23 is entered.

For example, before assigning (or trying to assign) the required bandwidth BW_EP_required1 of the currently selected endpoint (e.g., the added endpoint as determined in Step S13) to the currently selected endpoint, the resource calculator 114 has determined the bandwidth usage information BW_usage_info(m) (e.g., the current bandwidth BW(m) or the remaining local/BI-owned bandwidth BW_remain_local(m)) of the target BI BI(m) (e.g., the BI BI(m) indicated by the BI index that is just found in Step S19) in Step S20. At a first time point at which Step S21 is executed, the resource calculator 114 may determine whether the current bandwidth BW(m) of the target BI BI(m) has reached the predetermined bandwidth limit per BI BW_limit_per_BI such as 10 Gbps (or whether the remaining local/BI-owned bandwidth BW_remain_local(m) has reached zero), in order to determine whether to execute Step S22 directly. If the current bandwidth BW(m) of the target BI BI(m) has reached the predetermined bandwidth limit per BI BW_limit_per_BI such as 10 Gbps (or the remaining local/BI-owned bandwidth BW_remain_local(m) has reached zero), the resource calculator 114 may execute Step S22 directly, having no need to calculate any target bandwidth BW_target1 of the target BI BI(m), such as the target bandwidth BW_target1 that would be calculated in Step S23.

In Step S22, the xHC 110 may utilize the resource calculator 114 to report the status of Bandwidth not Available to the scheduler 112. For example, the resource calculator 114 may send the Bandwidth Available indication signal carrying the Bandwidth Available indication to the scheduler 112, with the Bandwidth Available indication indicating the status of Bandwidth not Available. Afterward, Step S30 shown in FIG. 5 is entered via the node B.

In Step S23, the xHC 110 may utilize the resource calculator 114 to determine whether there remains a sufficient local (or BI-owned) bandwidth BW_remain_local(m) available for use (labeled “Bandwidth Available” for brevity) within the quota corresponding to the predetermined bandwidth limit per BI BW_limit_per_BI. If Yes, Step S26 is entered; if No, Step S24 is entered.

The xHC 110 may perform the associated operations corresponding to the aforementioned any example among the examples respectively shown in Table 2A and Table 2B. When adopting the example shown in Table 2A, in Step S23, the xHC 110 may utilize the resource calculator 114 to determine whether there remains a sufficient local (or BI-owned) bandwidth BW_remain_local(m) available for use within the quota corresponding to the predetermined bandwidth limit per BI BW_limit_per_BI by calculating the target bandwidth BW_target1 of the target BI BI(m) (e.g., the BI BI(m) indicated by the BI index that is just found in Step S19) and comparing the target bandwidth BW_target1 of the target BI BI(m) with the predetermined bandwidth limit per BI BW_limit_per_BI such as 10 Gbps, where the resource calculator 114 may execute Step S24 if BW_target1>BW_limit_per_BI, or execute Step S26 if BW_target1≤BW_limit_per_BI, but the present invention is not limited thereto. When adopting the example shown in Table 2B, in Step S23, the xHC 110 may utilize the resource calculator 114 to determine whether there remains a sufficient local (or BI-owned) bandwidth BW_remain_local(m) available for use within the quota corresponding to the predetermined bandwidth limit per BI BW_limit_per_BI by comparing the required bandwidth BW_EP_required1 of the currently selected endpoint (e.g., the added endpoint as determined in Step S13) with the local (or BI-owned) bandwidth BW_remain_local(m), where the resource calculator 114 may execute Step S24 if BW_EP_required1>BW_remain_local(m), or execute Step S26 if BW_EP_required1≤BW_remain_local(m).

More particularly, the resource calculator 114 may determine whether the target bandwidth BW_target1 of the target BI BI(m) exceeds the predetermined bandwidth limit per BI BW_limit_per_BI. For example, before assigning (or trying to assign) the required bandwidth BW_EP_required1 of the currently selected endpoint (e.g., the added endpoint as determined in Step S13) to the currently selected endpoint, the resource calculator 114 has determined the current bandwidth BW(m) of the target BI BI(m) (e.g., the BI BI(m) indicated by the BI index that is just found in Step S19) in Step S20, and the current bandwidth BW(m) of the target BI BI(m) does not exceed the predetermined bandwidth limit per BI BW_limit_per_BI such as 10 Gbps. At a second time point at which Step S23 is executed, the resource calculator 114 may calculate the target bandwidth BW_target1 of the target BI BI(m) according to the following equation:

BW_target1=BW(m)+BW_EP_required1;

where “BW(m)” may represent the current bandwidth BW(m) of the target BI BI(m) (e.g., the BI BI(m) indicated by the BI index that is just found in Step S19), and the required bandwidth BW_EP_required1 may represent the bandwidth required by the currently selected endpoint such as the added endpoint as determined in Step S13. In addition, if the target bandwidth BW_target1 of the target BI BI(m) exceeds the predetermined bandwidth limit per BI BW_limit_per_BI, the resource calculator 114 may determine that there does not remain any local (or BI-owned) bandwidth BW_remain_local(m) available for use within the quota corresponding to the predetermined bandwidth limit per BI BW_limit_per_BI according to the comparison result of BW_target1>BW_limit_per_BI, and therefore execute Step S24; otherwise, when determining that the target bandwidth BW_target1 of the target BI BI(m) does not exceed the predetermined bandwidth limit per BI BW_limit_per_BI, the resource calculator 114 may determine that there remains the local (or BI-owned) bandwidth BW_remain_local(m) available for use within the quota corresponding to the predetermined bandwidth limit per BI BW_limit_per_BI according to the comparison result of BW_target1≤BW_limit_per_BI, and therefore execute Step S26.

In Step S24, the xHC 110 may utilize the resource calculator 114 to search at least one next available BI BI(m′) among the (M+1) BIs {BI(0), BI(1), . . . , BI(M)} that has the bandwidth BW(m′) less than the predetermined bandwidth limit per BI BW_limit_per_BI, in order to collect any remaining local (or BI-owned) bandwidth BW_remain_local(m′) available for use within the quota corresponding to the predetermined bandwidth limit per BI BW_limit_per_BI from the aforementioned at least one next available BI BI(m′), for being used by the target BI BI(m) (e.g., the BI BI(m) indicated by the BI index that is just found in Step S19).

The resource calculator 114 may determine whether to start executing Step S25 according to whether the upgraded bandwidth quota such as the summation (BW_limit_per_BI+BW_remain_local(m′)) of the predetermined bandwidth limit per BI BW_limit_per_BI and the aforementioned any remaining local (or BI-owned) bandwidth BW_remain_local(m′) collected from the aforementioned at least one next available BI BI(m′) is sufficient for being used. When determining that the target bandwidth BW_target1 of the target BI BI(m) does not exceed the summation (BW_limit_per_BI+BW_remain_local(m′)) mentioned above, the resource calculator 114 may determine that the upgraded bandwidth quota such as the summation (BW_limit_per_BI+BW_remain_local(m′)) is sufficient for being used, and therefore execute Step S25. For example, the aforementioned at least one next available BI BI(m′) may comprise a single next available BI BI(m′), and the resource calculator 114 may execute Step S25 when determining that the upgraded bandwidth quota such as the summation (BW_limit_per_BI+BW_remain_local(m′)) of the predetermined bandwidth limit per BI BW_limit_per_BI and the remaining local (or BI-owned) bandwidth BW_remain_local(m′) collected from the single next available BI BI(m′) is sufficient for being used. For another example, the aforementioned at least one next available BI BI(m′) may comprise multiple next available BIs {BI(m′)} such as the BIs {BI(m′(1)), BI(m′(2)), . . . }, and the resource calculator 114 may execute Step S25 when determining that the upgraded bandwidth quota such as the summation (BW_limit_per_BI+BW_remain_local(m′(1))+BW_remain_local(m′(2))+ . . . ) of the predetermined bandwidth limit per BI BW_limit_per_BI and the remaining local (or BI-owned) bandwidths {BW_remain_local(m′(1)), BW_remain_local(m′(2)), . . . } collected from the multiple next available BIs {BI(m′)} such as the BIs {BI(m′(1)), BI(m′(2)), . . . } is sufficient for being used.

In Step S25, the xHC 110 may utilize the resource calculator 114 to decrease (or subtract) the required bandwidth BW_EP_required1 of the currently selected endpoint (e.g., the added endpoint as determined in Step S13) from the associate information and update the bandwidth information of the table.

The xHC 110 may perform the associated operations corresponding to the aforementioned any example among the examples respectively shown in Table 2A and Table 2B. When adopting the example shown in Table 2A, in Step S25, the xHC 110 may utilize the resource calculator 114 to decrease (or subtract) the required bandwidth BW_EP_required1 of the currently selected endpoint (e.g., the added endpoint as determined in Step S13) from the remaining bandwidth BW_remain to make the remaining bandwidth BW_remain decrease with a decrement of the required bandwidth BW_EP_required1 of the currently selected endpoint, and update the bandwidth information of the table, such as the latest bandwidth BW(m) used by the target BI BI(m) (e.g., the BI BI(m) indicated by the BI index that is just found in Step S19) on the BI bandwidth table 412, for example, by adding the required bandwidth BW_EP_required1 of the currently selected endpoint (e.g., the added endpoint) into the current bandwidth BW(m) of the target BI BI(m) on the BI bandwidth table 412, in order to obtain the required bandwidth BW_EP_required1 of the added endpoint from the remaining bandwidth BW_remain, where the target BI BI(m) may represent the BI BI(m) corresponding to the root hub port HCP(i) onto which the added endpoint is just added, but the present invention is not limited thereto. When adopting the example shown in Table 2B, in Step S25, the xHC 110 may utilize the resource calculator 114 to decrease (or subtract) the required bandwidth BW_EP_required1 of the currently selected endpoint (e.g., the added endpoint as determined in Step S13) from both of the local (or BI-owned) bandwidth BW_remain_local(m) and the aforementioned any remaining local (or BI-owned) bandwidth BW_remain_local(m′), and update the bandwidth information of the table, such as the local (or BI-owned) bandwidth BW_remain_local(m) and the aforementioned any remaining local (or BI-owned) bandwidth BW_remain_local(m′) on the BI bandwidth table 412.

In Step S26, the xHC 110 may utilize the resource calculator 114 to report the status of Bandwidth Available to the scheduler 112. For example, the resource calculator 114 may send the Bandwidth Available indication signal carrying the Bandwidth Available indication to the scheduler 112, with the Bandwidth Available indication indicating the status of Bandwidth Available. Afterward, Step S30 shown in FIG. 5 is entered via the node B.

In Step S27, the xHC 110 may utilize the resource calculator 114 to perform lookup (e.g., another first lookup operation) on the BI port mapping table 411 to search the BI index of the currently selected endpoint (e.g., the dropped endpoint as determined in Step S15), for determining that another target BI BI(m) for managing the currently selected endpoint is the BI BI(m) indicated by this BI index among the BIs {BI(m)|m=0, . . . , M}.

In Step S28, the xHC 110 may utilize the resource calculator 114 to perform lookup (e.g., another second lookup operation) on the BI bandwidth table 412 according to the BI index (e.g., the BI index that is just found in Step S27), to determine the bandwidth usage information BW_usage_info(m) of the other target BI BI(m) (e.g., the BI BI(m) indicated by the BI index that is just found in Step S27).

The xHC 110 may perform the associated operations corresponding to the aforementioned any example among the examples respectively shown in Table 2A and Table 2B. When adopting the example shown in Table 2A, in Step S28, the xHC 110 may utilize the resource calculator 114 to perform the lookup (e.g., the other second lookup operation) on the BI bandwidth table 412 according to the BI index (e.g., the BI index that is just found in Step S27), to determine the bandwidth usage information BW_usage_info(m) of the other target BI BI(m), such as the current bandwidth BW(m) of the other target BI BI(m). When adopting the example shown in Table 2B, in Step S28, the xHC 110 may utilize the resource calculator 114 to perform the lookup (e.g., the other second lookup operation) on the BI bandwidth table 412 according to the BI index (e.g., the BI index that is just found in Step S27), to determine the bandwidth usage information BW_usage_info(m) of the other target BI BI(m), such as the local (or BI-owned) bandwidth BW_remain_local(m) of the other target BI BI(m).

In Step S29, the xHC 110 may utilize the resource calculator 114 to add the required bandwidth BW_EP_required2 of the currently selected endpoint (e.g., the dropped endpoint as determined in Step S15) into the associate information and update the bandwidth information of the table.

The xHC 110 may perform the associated operations corresponding to the aforementioned any example among the examples respectively shown in Table 2A and Table 2B. When adopting the example shown in Table 2A, in Step S29, the xHC 110 may utilize the resource calculator 114 to add the required bandwidth BW_EP_required2 of the currently selected endpoint (e.g., the dropped endpoint as determined in Step S15) into the remaining bandwidth BW_remain to make the remaining bandwidth BW_remain increase with an increment of the required bandwidth BW_EP_required2 of the currently selected endpoint, and update the bandwidth information of the table, such as the latest bandwidth BW(m) used by the other target BI BI(m) (e.g., the BI BI(m) indicated by the BI index that is just found in Step S27) on the BI bandwidth table 412, for example, by subtracting the required bandwidth BW_EP_required2 of the currently selected endpoint (e.g., the dropped endpoint) from the current bandwidth BW(m) of the other target BI BI(m) on the BI bandwidth table 412, in order to release the required bandwidth BW_EP_required2 of the dropped (or removed) endpoint into the remaining bandwidth BW_remain, where the other target BI BI(m) may represent the BI BI(m) corresponding to the root hub port HCP(i) from which the dropped endpoint is just removed, but the present invention is not limited thereto. When adopting the example shown in Table 2B, in Step S29, the xHC 110 may utilize the resource calculator 114 to add the required bandwidth BW_EP_required2 of the currently selected endpoint (e.g., the dropped endpoint as determined in Step S15) into the local (or BI-owned) bandwidth BW_remain_local(m), and update the bandwidth information of the table, such as the local (or BI-owned) bandwidth BW_remain_local(m) on the BI bandwidth table 412. Afterward, Step S31 shown in FIG. 5 is entered via the node C.

In Step S30, the xHC 110 may utilize the scheduler 112 to determine whether the resource calculator 114 reports the status of Bandwidth Available to the scheduler 112. If Yes, Step S31 is entered; if No, in a situation where the resource calculator 114 reports the status of Bandwidth not Available to the scheduler 112, Step S32 is entered. For example, the scheduler 112 may receive the Bandwidth Available indication signal carrying the Bandwidth Available indication from the resource calculator 114, with the Bandwidth Available indication indicating the status of Bandwidth Available, and therefore execute Step S31. For another example, the scheduler 112 may receive the Bandwidth Available indication signal carrying the Bandwidth Available indication from the resource calculator 114, with the Bandwidth Available indication indicating the status of Bandwidth not Available, and therefore execute Step S32.

In Step S31, the xHC 110 may utilize the scheduler 112 to report a successful event to at least one upper layer such as the aforementioned at least one software layer (or a certain driver therein) via the AP interface 111.

In Step S32, the xHC 110 may utilize the scheduler 112 to report a resource error event to the aforementioned at least one upper layer such as the aforementioned at least one software layer (or a certain driver therein) via the AP interface 111.

For better comprehension, the method may be illustrated with the scheduler-side working flow shown in FIG. 5 and the resource-calculator-side working flow shown in FIG. 6, but the present invention is not limited thereto. According to some embodiments, one or more steps may be added, deleted, or changed in any working flow among the scheduler-side working flow shown in FIG. 5 and the resource-calculator-side working flow shown in FIG. 6.

The USB host controller such as the xHC 110 can operate according to the method to dynamically manage the bandwidths {BW(0), BW(1), . . . , BW(M)} respectively used by the (M+1) BIs {BI(0), BI(1), . . . , BI(M)} of the xHC 110, and more particularly, increase the current bandwidth BW(m) of the target BI BI(m) (e.g., the BI BI(m) indicated by the BI index that is found in Step S19) with an increment of the required bandwidth BW_EP_required1 of the currently selected endpoint (e.g., the added endpoint) managed by the target BI BI(m) to reach the predetermined bandwidth limit per BI BW_limit_per_BI such as 10 Gbps for the USB system, having no need to be limited by an improper pseudo limit such as an equal share of the total available bandwidth BW_total_available of the USB controller as suggested in the pseudo limit bandwidth control scheme of the related art. For better comprehension, assume that one or more functions of the xHC 110 may be temporarily disabled to allow the electronic device 100 to operate according to the pseudo limit bandwidth control scheme, but the present invention is not limited thereto. Based on the pseudo limit bandwidth control scheme, each BI BI(m) among the (M+1) BIs {BI(m)|m=0, . . . , M} cannot know the bandwidths {BW(m)} that the other BIs {BI(m)} are using since they should be managed independently in the pseudo limit bandwidth control scheme. As the total bandwidth (e.g., the summation Σ_{m=0 . . . . M} BW(m), or (BW(0)+ . . . +BW(M))) of the bandwidths {BW(m)|m=0, . . . , M} respectively used by the BIs {BI(m)|m=0, . . . , M} cannot exceed the total available bandwidth BW_total_available, each BI BI(m) among the (M+1) BIs {BI(m)|m=0, . . . , M} can only be limited to use the equal share of the total available bandwidth BW_total_available, such as the average value (BW_total_available/(M+1)) obtained from dividing the total available bandwidth BW_total_available by the BI count (M+1) of the (M+1) BIs {BI(m)|m=0, . . . , M}. For example, there may be 4 Super-Speed Plus (SSP) root hub ports {PORT1, PORT2, PORT3, PORT4} corresponding to 4 BIs {BI(m)|m=0, . . . , 3}, and the bandwidth of the host interface may be equal to 30 Gbps and the bandwidth BW(m) of each BI BI(m) among the 4 BIs {BI(m)|m=0, . . . , 3} may be equal to 10 Gbps, which means BW_total_available=30 (Gbps) and BW_limit_per_BI=10 (Gbps). As each BI BI(m) among the 4 BIs {BI(m)|m=0, . . . , 3} cannot know the bandwidths {BW(m)} that the other BIs {BI(m)} are using when the xHC 110 is operating according to the pseudo limit bandwidth control scheme, the available bandwidth of each BI BI(m) should be equal to (30/4)=7.5 (Gbps), and therefore each root hub port PORT(x) among the 4 SSP root hub ports {PORT1, PORT2, PORT3, PORT4} can only use up to 7.5 Gbps. In a situation where each port PORT(x) among the 4 SSP root hub ports {PORT1, PORT2, PORT3, PORT4} is currently using the bandwidth of 5 Gbps, if it is needed to add an endpoint onto the port PORT1 and this endpoint requires the bandwidth of 5 Gbps, the new endpoint cannot be added successfully. In comparison with this, the xHC 110 operating according to the method can increase the current bandwidth BW(m) of the target BI BI(m) to reach the predetermined bandwidth limit per BI BW_limit_per_BI such as 10 Gbps. For example, in the same situation where each port PORT(x) among the 4 SSP root hub ports {PORT1, PORT2, PORT3, PORT4} is currently using the bandwidth of 5 Gbps, if it is needed to add the same endpoint onto the port PORT1 and this endpoint requires the bandwidth of 5 Gbps, the new endpoint can be added successfully. In addition, more endpoints can be added onto one or more other ports among the 4 SSP root hub ports {PORT1, PORT2, PORT3, PORT4}. As a result, at a subsequent time point, the SSP root hub ports PORT1, PORT2, PORT3 and PORT4 may have used the bandwidths of 10 Gbps, 7.5 Gbps, 7.5 Gbps and 5 Gbps, respectively. Therefore, the xHC 110 operating according to the method can dynamically manage the bandwidths {BW(0), BW(1), . . . , BW(M)} respectively used by the (M+1) BIs {BI(0), BI(1), . . . , BI(M)} to make the whole USB system reach an optimum performance.

According to some embodiments, the input context mentioned in Step S12 may comprise the Device Context. Assume that the xHC 110 may be implemented as a USB 3.0 host controller capable of having up to 255 devices, and each device may have up to 31 endpoints. The USB 3.0 data structures for representing the USB 3.0 host controller and the connected devices during the communication between the xHC 110 and the host controller driver in the aforementioned at least one software layer may comprise the Doorbell Register Array, the Device Context Base Array, the Command Ring and the associated TRB, as well as the Event ring and the associated TRB, and the Device Context Base Array may be an array of pointers to Device Context structures, where there may be one Device Context structure for each device connected to the host controller, with Elements 1 through 255 pointing to Device Context structures while Element 0 pointing to a context structure for the host controller. Regarding the Device Context and the Slot Context, a Device Context structure may hold an array of pointers to Endpoint Context structures, where there may be one Endpoint Context structure for each endpoint on the device, with Elements 1 through 31 pointing to Endpoint Context structures while Element 0 pointing to a Slot Context structure, which holds context information for the device. Additionally, the extensible host controller interface (xHCI) may provide information related to the root hub port HCP(i) of the endpoint EndPt to the xHC 110. When processing a command of a predetermined endpoint, the scheduler 112 may capture the content of the Endpoint Context stored in the system memory through the AP interface 111 to obtain the HCP information to find the corresponding BI.

According to some embodiments, the mapping relationships between the (M+1) BIs {BI(0), BI(1), . . . , BI(M)} and the (M+1) root hub ports {HCP(0), HCP(1), . . . , HCP(M)} as indicated by the BI and port mapping information on the BI port mapping table 411 may comprise the one-to-one mapping of the m^{th} BI BI(m) among the BIs {BI(m)|m=0, . . . , M} and the i^{th} root hub port HCP(i) among the root hub ports {HCP(i)|i=1, . . . , (M+1)}, and therefore i=(m+1), but the present invention is not limited thereto. According to some embodiments, it is unnecessary that i=(m+1).

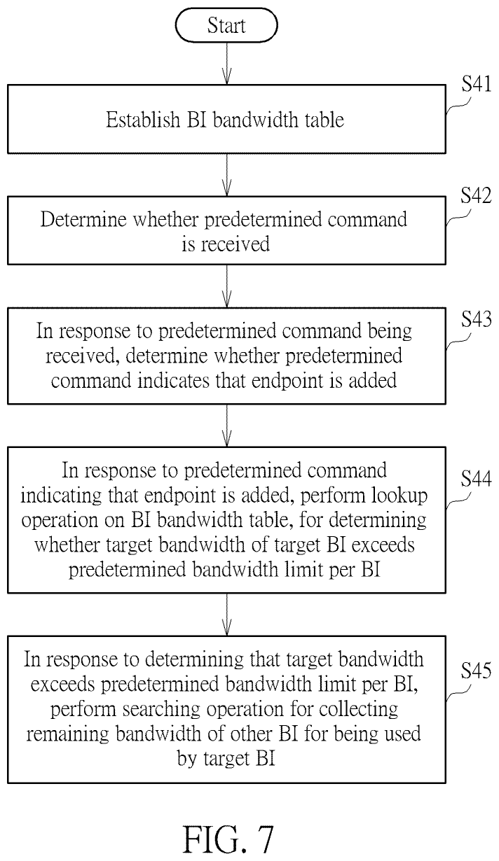

FIG. 7 illustrates a working flow of the method according to an embodiment of the present invention. The method can be applied to the USB host controller such as the xHC 110, and more particularly, can be applied to the AP interface 111, the scheduler 112, the transfer engine 113, the resource calculator 114 and the port routing circuit 115 shown in FIG. 1, where each of these components in the hardware architecture of the main circuit 101 may be regarded as a sub-circuit among the sub-circuits of the USB host controller (or the xHC 110). For example, the xHC 110 may utilize the AP interface 111 to interact with the aforementioned at least one software layer of the electronic device 100, utilize the scheduler 112 to fetch at least one command from the aforementioned at least one software layer via the AP interface 111 and report at least one event to the aforementioned at least one software layer via the AP interface 111, and utilize the resource calculator 114 to perform calculation regarding the BI resource management.

In Step S41, the xHC 110 may establish at least the BI bandwidth table 412 for recoding the bandwidths {BW(0), BW(1), . . . , BW(M)} respectively used by the (M+1) BIs {BI(0), BI(1), . . . , BI(M)} of the xHC 110, and more particularly, establish both of the BI port mapping table 411 and the BI bandwidth table 412, for performing the associated operations such as that of some steps as described in the embodiment shown in FIG. 5 and FIG. 6.

In Step S42, the xHC 110 may utilize the scheduler 112 to determine whether the predetermined command such as the Configure Endpoint Command is received. For example, the operation of Step S42 may comprise the operation of Step S11 shown in FIG. 5.

In Step S43, in response to the predetermined command such as the Configure Endpoint Command being received, the xHC 110 may utilize the scheduler 112 to determine whether the predetermined command such as the Configure Endpoint Command indicates that any endpoint is added. For example, the operation of Step S43 may at least comprise the operation of Step S13 shown in FIG. 5, and more particularly, may comprise the operations of Steps S12 and S13 shown in FIG. 5.

In Step S44, in response to the predetermined command such as the Configure Endpoint Command indicating that the aforementioned any endpoint is added, the xHC 110 may utilize the resource calculator 114 to perform at least one lookup operation (e.g., one or more lookup operations) on at least one table (e.g., one or more tables) within the xHC 110, and more particularly, at least perform a lookup operation on the BI bandwidth table 412, for determining whether a target bandwidth BW_target of a target BI BI(m) among the (M+1) BIs {BI(0), BI(1), . . . , BI(M)} exceeds the predetermined bandwidth limit per BI BW_limit_per_BI such as 10 Gbps. For example, the operation of Step S44 may at least comprise the operation of Step S20 shown in FIG. 6, and more particularly, may comprise the operations of Steps S19, S20, S21 and S23 shown in FIG. 6, where the target BI BI(m) mentioned in Step S44 may represent the target BI BI(m) indicated by the BI index (e.g., the BI index that is found in Step S19) mentioned in Step S20, and the target bandwidth BW_target mentioned in Step S44 may represent the aforementioned target bandwidth BW_target1 of the target BI BI(m) (e.g., the BI BI(m) indicated by the BI index that is found in Step S19).

In Step S45, in response to determining that the target bandwidth BW_target exceeds the predetermined bandwidth limit per BI BW_limit_per_BI such as 10 Gbps, the xHC 110 may utilize the resource calculator 114 to perform at least one searching operation for collecting at least one remaining bandwidth BW(m) of at least one other BI BI(m) for being used by the target BI BI(m), and more particularly, re-assign the aforementioned at least one remaining bandwidth BW(m) to the target BI BI(m). For example, the operation of Step S45 may comprise the operation of Step S24 shown in FIG. 6, where the aforementioned at least one other BI BI(m) may represent the aforementioned at least one next available BI BI(m′), and the aforementioned at least one remaining bandwidth BW(m) may represent the aforementioned any remaining local (or BI-owned) bandwidth BW_remain_local(m′) collected from the aforementioned at least one next available BI BI(m′).

For better comprehension, the method may be illustrated with the working flow shown in FIG. 7, but the present invention is not limited thereto. According to some embodiments, one or more steps may be added, deleted, or changed in the working flow shown in FIG. 7. For example, the xHC 110 may perform one or more additional steps such as some more steps of at least one working flow among the scheduler-side working flow shown in FIG. 5 and the resource-calculator-side working flow shown in FIG. 6. For brevity, similar descriptions for these embodiments are not repeated in detail here.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for performing bus instance (BI) resource management in a universal serial bus (USB) host controller, the method being applicable to the USB host controller, the method comprising:
establishing a BI bandwidth table for recoding respective bandwidth usage information of multiple BIs of the USB host controller;
utilizing a scheduler within the USB host controller to determine whether a predetermined command is received;
in response to the predetermined command being received, utilizing the scheduler to determine whether the predetermined command indicates that any endpoint is added;
in response to the predetermined command indicating that the any endpoint is added, utilizing a resource calculator within the USB host controller to at least perform a lookup operation on the BI bandwidth table, for determining whether a target bandwidth of a target BI among the multiple BIs exceeds a predetermined bandwidth limit per BI; and
in response to determining that the target bandwidth exceeds the predetermined bandwidth limit per BI, utilizing the resource calculator to perform at least one searching operation for collecting at least one remaining bandwidth of at least one other BI for being used by the target BI.

2. The method of claim 1, wherein the USB host controller represents an extensible host controller (xHC).

3. The method of claim 2, wherein the predetermined command represents a configure endpoint command.

4. The method of claim 1, wherein utilizing the scheduler within the USB host controller to determine whether the predetermined command is received further comprises:
utilizing the scheduler to fetch at least one input context from the predetermined command; and
utilizing the scheduler to determine whether the predetermined command is received according to the at least one input context of the predetermined command.

5. The method of claim 1, wherein utilizing the scheduler to determine whether the predetermined command indicates that the any endpoint is added further comprises:
utilizing the scheduler to fetch at least one input context from the predetermined command; and
utilizing the scheduler to determine whether the any endpoint is added according to the at least one input context of the predetermined command.

6. The method of claim 1, wherein the USB host controller is arranged to establish a first BI-related table and a second BI-related table, for performing a first lookup operation and a second lookup operation on the first BI-related table and the second BI-related table, respectively, wherein the first BI-related table represents a mapping table, and the second BI-related table represents the BI bandwidth table; and utilizing the resource calculator within the USB host controller to at least perform the lookup operation on the BI bandwidth table, for determining whether the target bandwidth of the target BI among the multiple BIs exceeds the predetermined bandwidth limit per BI further comprises:
utilizing the resource calculator to perform the first lookup operation on the mapping table to search a BI index of a currently selected endpoint, for determining that the target BI for managing the currently selected endpoint is a BI indicated by the BI index among the multiple BIs, wherein the currently selected endpoint represents an added endpoint which is the any endpoint that is added; and
utilizing the resource calculator to perform the second lookup operation on the BI bandwidth table according to the BI index, to determine a current bandwidth of the target BI, for determining whether the target bandwidth exceeds the predetermined bandwidth limit per BI at least according to the current bandwidth.

7. The method of claim 6, wherein utilizing the resource calculator within the USB host controller to at least perform the lookup operation on the BI bandwidth table, for determining whether the target bandwidth of the target BI among the multiple BIs exceeds the predetermined bandwidth limit per BI further comprises:
utilizing the resource calculator to determine whether the current bandwidth of the target BI has reached the predetermined bandwidth limit per BI, for generating at least one determination result; and
in response to a first determination result among the at least one determination result indicating that the current bandwidth of the target BI has not reached the predetermined bandwidth limit per BI, utilizing the resource calculator to perform at least one calculation operation according to the current bandwidth of the target BI and a required bandwidth of the currently selected endpoint to generate the target bandwidth of the target BI, for determining whether the target bandwidth exceeds the predetermined bandwidth limit per BI.

8. The method of claim 7, wherein the resource calculator is arranged to calculate a summation of the current bandwidth of the target BI and the required bandwidth of the currently selected endpoint to be the target bandwidth of the target BI.

9. The method of claim 7, wherein the at least one determination result comprises multiple determination results, and the multiple determination results comprise the first determination result; an operation of utilizing the resource calculator to determine whether the current bandwidth of the target BI has reached the predetermined bandwidth limit per BI is performed multiple times to generate the multiple determination results, respectively; and the method further comprises:
in response to a second determination result among the multiple determination results indicating that the current bandwidth of the target BI has reached the predetermined bandwidth limit per BI, utilizing the resource calculator to report a status of bandwidth not available to the scheduler.

10. The method of claim 1, wherein an operation of utilizing the resource calculator within the USB host controller to at least perform the lookup operation on the BI bandwidth table for determining whether the target bandwidth of the target BI among the multiple BIs exceeds the predetermined bandwidth limit per BI is performed multiple times to generate multiple determination results, respectively; the multiple determination results comprise a third determination result indicating that the target bandwidth exceeds the predetermined bandwidth limit per BI, and further comprise a fourth determination result indicating that the target bandwidth does not exceed the predetermined bandwidth limit per BI; an operation of utilizing the resource calculator to perform the at least one searching operation for collecting the at least one remaining bandwidth of the at least one other BI for being used by the target BI is performed in response to the third determination result; and the method further comprises:
in response to the fourth determination result indicating that the target bandwidth does not exceed the predetermined bandwidth limit per BI, utilizing the resource calculator to report a status of bandwidth available to the scheduler.

11. A universal serial bus (USB) host controller, configured for performing bus instance (BI) resource management, the USB host controller being positioned within an electronic device, the USB host controller comprising:
multiple sub-circuits, comprising:
an application (AP) interface, arranged to interact with at least one software layer of the electronic device;
a scheduler, coupled to the AP interface, arranged to fetch at least one command from the at least one software layer via the AP interface, and report at least one event to the at least one software layer via the AP interface; and
a resource calculator, coupled to the scheduler, arranged to perform calculation regarding BI resource management;
wherein:
the USB host controller is arranged to establish a BI bandwidth table for recoding respective bandwidth usage information of multiple BIs of the USB host controller;
the scheduler is arranged to determine whether a predetermined command is received;
in response to the predetermined command being received, the scheduler is arranged to determine whether the predetermined command indicates that any endpoint is added;
in response to the predetermined command indicating that the any endpoint is added, the resource calculator is arranged to at least perform a lookup operation on the BI bandwidth table, for determining whether a target bandwidth of a target BI among the multiple BIs exceeds a predetermined bandwidth limit per BI; and
in response to determining that the target bandwidth exceeds the predetermined bandwidth limit per BI, the resource calculator is arranged to perform at least one searching operation for collecting at least one remaining bandwidth of at least one other BI for being used by the target BI.

12. An electronic device, configured for performing bus instance (BI) resource management, the electronic device comprising:
a main circuit, comprising:
a universal serial bus (USB) host controller, comprising:
multiple sub-circuits, comprising:
an application (AP) interface, arranged to interact with at least one software layer of the electronic device;
a scheduler, coupled to the AP interface, arranged to fetch at least one command from the at least one software layer via the AP interface, and report at least one event to the at least one software layer via the AP interface; and
a resource calculator, coupled to the scheduler, arranged to perform calculation regarding BI resource management;
wherein:
the USB host controller is arranged to establish a BI bandwidth table for recoding respective bandwidth usage information of multiple BIs of the USB host controller;
the scheduler is arranged to determine whether a predetermined command is received;
in response to the predetermined command being received, the scheduler is arranged to determine whether the predetermined command indicates that any endpoint is added;
in response to the predetermined command indicating that the any endpoint is added, the resource calculator is arranged to at least perform a lookup operation on the BI bandwidth table, for determining whether a target bandwidth of a target BI among the multiple BIs exceeds a predetermined bandwidth limit per BI; and
in response to determining that the target bandwidth exceeds the predetermined bandwidth limit per BI, the resource calculator is arranged to perform at least one searching operation for collecting at least one remaining bandwidth of at least one other BI for being used by the target BI.
